(19) United States
(12) Patent Application Publication
(10) Pub. No.: US 2009/0140867 A1
(43) Pub. Date: Jun. 4, 2009

(54) Pressure vessel apparatus with sensing identification function

(75) Inventors: Wen Cheng Yin, Taipei County (TW); Wen Hao Lin, Taipei County (TW); Ho-Chuan Hsu, Kaohsiung County (TW); Fu-Jung Chen, Taipei County (TW)

Correspondence Address: BACON & THOMAS, PLLC, 625 SLATERS LANE, FOURTH FLOOR, ALEXANDRIA, VA, 22314-1176, US

(73) Assignee: Taiwan Name Plate Co., Ltd, Taoyuan County (TW)

(21) Appl. No.: 12/149,965

(22) Filed: May 12, 2008

(30) Foreign Application Priority Data
Dec. 3, 2007 (TW) 096145990

(51) Int. Cl. G08B 21/00

(52) U.S. Cl. 340/626

(57) ABSTRACT

The present invention discloses a pressure vessel apparatus with sensing identification function, comprising a pressure vessel body and an an identification tag. The pressure vessel body has a concave container located on its surface. The identification tag is located in the concave container, comprising a record IC and a communication unit. The record IC is used for recording the status information of the pressure vessel body. When the reading device reads the identification tag, and thus provides an identification signal such that the communication unit transmits the status information to the reading device to verify whether the lifetime of the pressure vessel apparatus was expired. Moreover, a sensing unit is applied for detecting the varying status of the content in the pressure vessel body, and such information is provided to the reading device as a judging reference for content filling and the pressure reading of the pressure vessel apparatus, in order to improve the safety of the pressure vessel apparatus.

### FIELD OF THE INVENTION

The present invention relates to a pressure vessel apparatus with sensing identification function, and more particularly to a pressure vessel apparatus using radio frequency identification (RFID) tags.

### BACKGROUND OF THE INVENTION

The pressure vessel used nowadays, such as bottled gas, oxygen bottle or nitrogen bottle, are normally with a sticker on the surface of the pressure vessel to indicate its origin, expiration date, contents, and etc. Take bottle gas as an example, it is one of the necessary goods in most families, street vendors and restaurants. As is well known in the prior arts, the bottled gas has a name plate on the surface of the holder by anchors. The name plate records the information, such as the production date, the expiration date, the net weight, the gross weight, the manufacturer name, the examination date and so on. The information thereof seems clearly at a first glance, however, the question is that the name plate is replaceable, that some of dishonored vendors may cheat their customer by replacing the name plate directly or with valid expiration date in the consideration of cost saving. In this case, it causes serious troubles as well as hidden risks towards consumers.

In view of the shortcomings of the prior art, the inventor of the present invention based on years of experience to conduct extensive researches and experiments, and finally developed a pressure vessel apparatus with sensing identification function to overcome the shortcomings of the prior art.

### SUMMARY OF THE INVENTION

Accordingly, the object of the present invention is to provide a pressure vessel apparatus with sensing identification function to provide a solution for the replaceable or removable tags so as to prevent the issues of hiding the fact of invalid or expired condition.

To achieve the foregoing object, the present invention provides a pressure vessel apparatus with sensing identification function, comprising a pressure vessel body and an identification tag. The pressure vessel body has a concave container, located on its surface, and the identification tag, located in the concave container, and it comprises a record IC and a communication unit. The record IC is used for recording the status information of the pressure vessel body. When the reading device reads the identification tag and thus provides an identification signal, the communication unit will transmit the status information to the reading device for verification. (When the communication unit and the reading device distanced appropriately, the radio frequency signal from the communication unit and the radio frequency signal from the reading device will interact with each other to have a wireless mechanism, therefore, the status information in the record IC will be transmitted back to the reading device via the wireless mechanism.)

The pressure vessel body is a pressure steel bottle, and more particularly the pressure steel bottle is a steel bottle which can withstand high pressure. The identification tag is glued to the concave container by a viscose and it can be a radio frequency identification (RFID) tag. The identification tag is made by material which can withstand high temperature, low temperature, or material of sand blasting, water and fire proof, or other material which is capable of resisting environmentally harsh conditions. The pressure vessel body is used for containing the content, in which the content is liquefied petroleum gas (LPG), oxygen, nitrogen or other gases. The status information comprises the production date, the initial content volume, and the examiner name. The communication unit can be an antenna. Moreover, the reading device is attached to an attachment device, in which the attachment device is a gas filler.

Within the advantage of the identification can be fixed to the pressure vessel apparatus and thus is not replaced easily, it can be used as the purpose of identification (ID) marking, therefore, it gives a solution for replaceable name plate and prevents the issues of hiding the fact of invalid or expiration date.

Moreover, the second object of this present invention is to provide a pressure vessel apparatus with sensing identification function, by particularly using a sensing unit to detect the changing status of the content in the pressure vessel apparatus.

To achieve the foregoing object, the present invention provides a pressure vessel apparatus with sensing identification function comprising a pressure vessel body, a sensing unit, an identification tag and a reading device. The pressure vessel body has a concave container located on its surface. The sensing unit is located on the surface of the pressure vessel apparatus for detecting the status information of the content in the pressure vessel body and generating a detecting result. The identification tag is located in the concave container and electrically connected to the sensing unit. The identification tag comprises a record IC and a communication unit. The record IC is used for recording the preset status information of the pressure vessel body and the detecting result from the sensing unit. When the reading device reads the identification tag and thus provides an identification signal, the communication unit will transmit the preset status information and the detecting result to the reading device for verification. The reading device can then update the preset status information and transmit it back to the record IC via the communication unit for next validation.

The detecting result relates to the residual content volume. The preset status information comprises the production date, the initial content volume, the examiner name and the expiration date. The sensing unit can be a mechanical sensor or an electronic sensor. The status information of the content in the pressure vessel apparatus comprises the information of gravity, pressure, temperature and other related physical attributes. Moreover, the present invention includes a power supply unit, which can be installed in the pressure vessel body, for providing the desired power to the sensing unit and the identification tag for operation. The power supply unit can be a battery or a wireless battery, in which the wireless charging unit is used for receiving an electromagnetic wave which is then converted to current for storage. The identification signal can be a radio frequency identification (RFID) signal.

To make our examiner to understand the technical characteristics and effects of the present invention, we use preferred embodiments with related drawings for the detail description of the present invention.

### BRIEF DESCRIPTION OF THE DRAWINGS

FIG. 1 is a schematic block diagram of a pressure vessel apparatus with sensing identification function of the present invention;

FIG. 2 is a detail schematic block diagram of a pressure vessel apparatus with sensing identification function of the present invention;

FIG. 3 is a schematic view of a pressure vessel apparatus with sensing identification function of the present invention;

FIG. 4 is a schematic view of a pressure vessel apparatus with sensing identification function of the present invention with a reading device attaching to a gas filler;

FIG. 5 is a schematic block diagram of a pressure vessel apparatus with sensing identification function in accordance with a preferred embodiment of the present invention;

FIG. 6 is a detail schematic block diagram of a pressure vessel apparatus with sensing identification function in accordance with a preferred embodiment of the present invention;

FIG. 7 is a schematic block diagram of a pressure vessel apparatus with sensing identification function in accordance with a preferred embodiment of the present invention; and

FIG. 8 is a schematic view of a pressure vessel apparatus with sensing identification function of the present invention with a PDA attaching to a gas filler.

### DETAILED DESCRIPTION OF THE PREFERRED EMBODIMENTS

The forgoing and other objects, features and advantages of the present invention will be better understood from the following detailed description taken with the accompanying drawing, and the same referring numerals are used for the same components in accordance with the present invention.

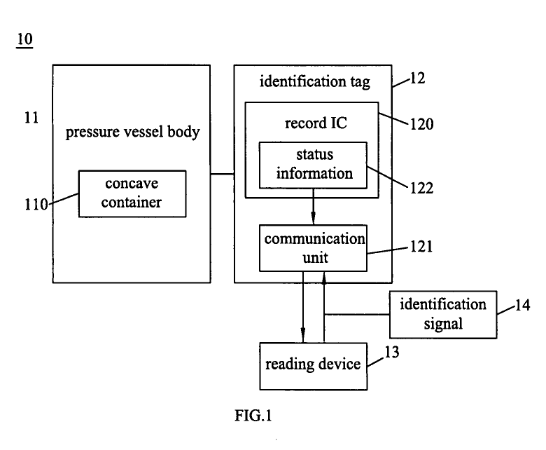

Referring to FIG. 1 for a schematic block diagram of a pressure vessel apparatus with sensing identification function of the present invention. The present invention provides a pressure vessel apparatus 10 with sensing identification function comprising a pressure vessel body 11 and an identification tag 12. The pressure vessel body 11 has a concave container 110 located on its surface. The identification tag 12 is located in the concave container 110, comprising a record IC 120 and a communication unit 121. The record IC 120 is used for recording the status information 122 of the pressure vessel body 11. When the reading device 13 reads the identification tag 12 and thus provides an identification signal 14, the communication unit 121 transmits the status information 122 to the reading device 13 for verification. When the communication unit 121 and the reading device 13 distanced appropriately, the radio frequency signal from the communication unit 121 and the radio frequency signal from the reading device 13 will interact with each other to have a wireless mechanism, therefore, the status information 122 in the record IC 120 will be transmitted back to the reading device 13 via the wireless mechanism by communication unit 121.

The pressure vessel body 11 is a pressure steel bottle, and more particularly the pressure steel bottle is a steel bottle capable of withstanding high pressure. The identification tag 12 is glued to the concave container 110 by a viscose and is a radio frequency identification (RFID) tag. The identification tag 12 is made by material which can withstand high temperature, low temperature, material of sand blasting, water and fire proof, or other material which is capable of resisting environmentally harsh conditions. The pressure vessel body 11 is used for containing the content, in which the content can be the liquefied petroleum gas, oxygen, nitrogen or other gases. The status information 122 comprises the production date, the initial content volume, and the examiner name. The communication unit 121 can be an antenna. Moreover, the reading device 13 is attached to an attachment device (not shown in FIG. 1), in which the attachment device can be a gas filler. The identification signal 14 is a radio frequency identification signal.

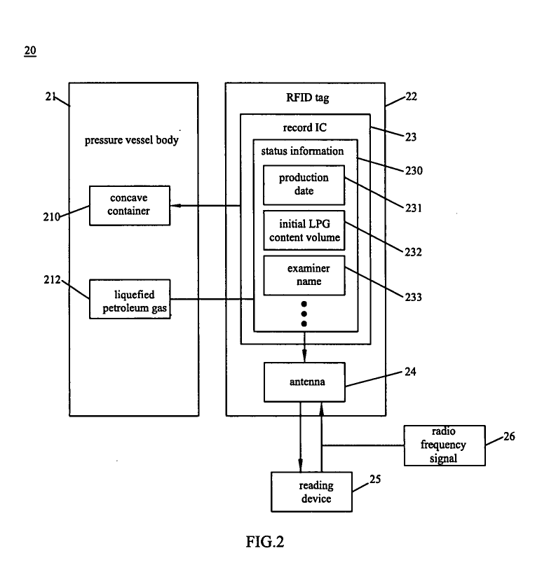

Referring to FIG. 2 for a detail schematic block diagram of a pressure vessel apparatus with sensing identification function of the present invention and taking bottled gas as an example. The LPG steel bottle apparatus 20 comprises a LPG steel bottle pressure vessel body 21 and a radio frequency identification (RFID) tag 22. The pressure vessel body 21 has a concave container 210 located on its surface. The RFID tag 22 is located in the concave container 210 by a viscose or other sticky materials. The RFID tag 22 is not easy to remove since it had been glued. The RFID tag 22 comprises a record IC 23 and an antenna 24. The record IC 23 is used for recording the status information 230 of the liquefied petroleum gas 212 which existed in the LPG steel bottle pressure vessel body 21. The status information 230 comprises the production date 231, the initial LPG content volume 232, and the examiner name 233. Here, the status information 230 can comprise more information and is not limited by those already mentioned above. When a reading device 25 reads the RFID tag 22, and provides a radio frequency signal 26, the antenna 24 will transmit the status information 230 to the reading device 25 for verification. Here, the reading device 25 can be a personal digital assistant (PDA) or other related portable electronic apparatus. The information about expiration date or other related information of the LPG steel bottle pressure vessel body 21 will be record in the reading device for verification and showing on the display unit of reading device 25.

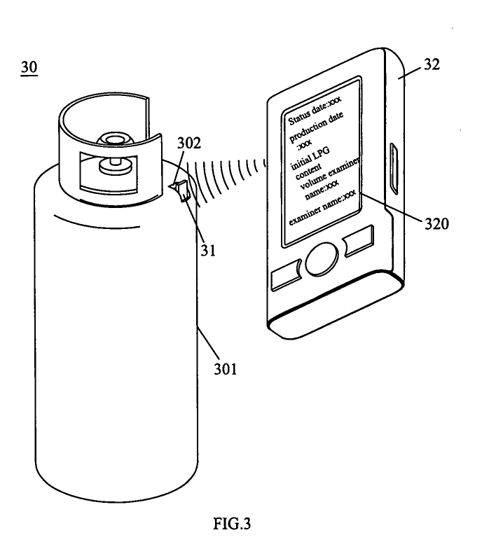

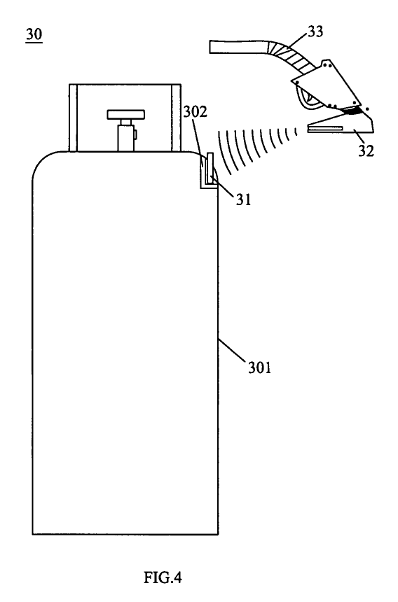

Referring to FIGS. 3 and 4 for a schematic view of a LPG steel bottle apparatus with sensing identification function of the present invention. The radio frequency identification (RFID) tag 31 is located in the concave container 302 on the surface 301 of the LPG steel bottle main body 30. The personal digital assistant (PDA) 32 with the RFID tag 31 can read the statues information as shown in FIG. 2 from the antenna to show the production date, the initial content volume, and the examiner name in the display 320 of the PDA 32 for operator to verify. Or, as shown in FIG. 4, the PDA 32 can attach to a gas filler 33 for gas filler assistant to verify when injecting the gas into the LPG steel bottle main body 30.

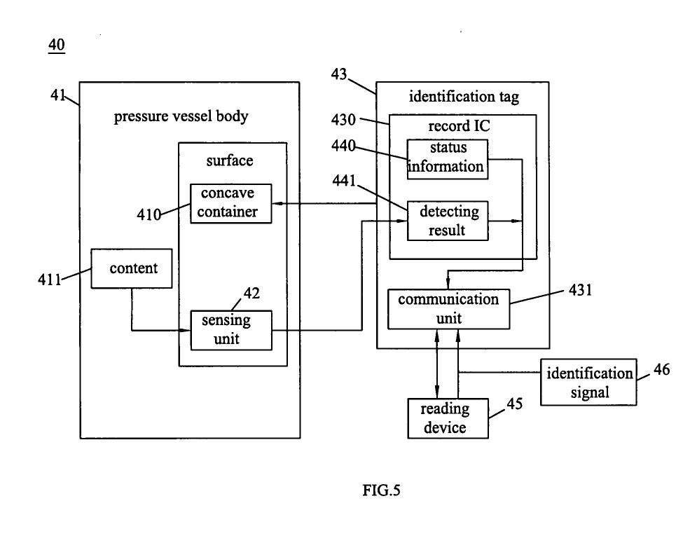

Referring to FIG. 5 for a schematic block diagram of a pressure vessel apparatus with sensing identification function in accordance with a preferred embodiment of the present invention. The pressure vessel comprises 40 a pressure vessel body 41, a sensing unit 42, an identification tag 43 and a reading device 45. The pressure vessel body has a concave container 410. The sensing unit 42 located on the surface 412 of the pressure vessel body 41, used for detecting the status information of a content 411 in the pressure vessel body 41 and generating a detecting result 441. The identification tag 43 is located in the concave container 410 and electrically connected to the sensing unit 42. The identification tag 43 comprises a record IC 430 and a communication unit 431. The record IC 430 is used for recording preset status information 440 of the pressure vessel body 41 and the detecting result 441 from the sensing unit 42. When the reading device 45 reads the identification tag 43 and thus provides an identification signal 46, the communication unit 431 transmits the preset status information 440 and the detecting result 441 to the reading device 43 for verification, thus the reading device 43 can update the preset status information 440 and transmit it back to the record IC 430 via the communication unit 431 for next validation.

The pressure vessel body 41 is a pressure steel bottle, and more particularly the pressure steel bottle is a steel bottle capable of withstanding high pressure. The identification tag 43 is glued to the concave container 410 by a viscose. The identification tag 43 can be a RFID tag. The identification tag 43 is made by material which can withstand high temperature, low temperature, material of sand blasting, water and fire proof, or other material which is capable of resisting environmentally harsh conditions. The content 411 can be the liquefied petroleum gas, oxygen, nitrogen or other gases. The preset status information 440 comprises the production date, the initial content volume, and the examiner name. The detecting result 441 relates to the residual content volume. The communication unit 431 can be an antenna. Moreover, the reading device 45 is attached to an attachment device (un-shown in the FIG.), and the attachment device can be a gas filler. The sensing unit 42 is a mechanical sensor or an electronic sensor. The status information of the content comprises the information of gravity, pressure, temperature and other related physical attributes. Moreover, the power supply unit (not shown in the FIG. 5) can be applied inside the pressure vessel body 41 for providing the power to the sensing unit 42 and the identification tag 43. The power supply unit can be a battery or a wireless battery, in which wireless charging unit is used for receiving an electromagnetic wave which is then converted to current for storage. The reading device 45 is attached to an attachment device (not shown in FIG. 5), and said attachment device can be a gas filler. Preferably, the identification signal 46 can be a RFID signal.

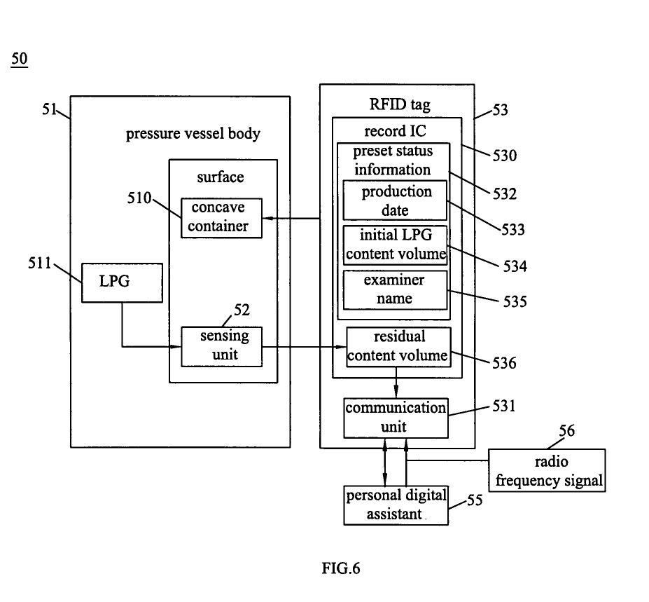

Referring to FIG. 6 for a detail schematic block diagram of a pressure vessel apparatus with sensing identification function in accordance with a preferred embodiment of the present invention and it takes bottled gas as an example. The LPG steel bottle 50 comprises a LPG steel bottle pressure vessel body 51, a sensing unit 52, a radio frequency identification (RFID) tag 53 and a personal digital assistant (PDA) 55. The pressure vessel body 51 has a concave container 510 on the surface 512 of the pressure vessel body 51. The identification tag 53 is glued to the concave container 510 by a viscose or other sticky materials and it is not easy to remove since it had been glued. The RFID tag 53 comprises a record IC 530 and a communication unit 531. The record IC 530 is used for recording the preset status information 532 of the LPG steel bottle pressure vessel body 51. The preset status information 532 comprises the production date 533, the initial LPG content volume 534, and the examiner name 535. The mechanical sensor is set on the surface 512 of the LPG steel bottle pressure vessel body 51 for detecting the changing status information, such as the information of pressure, temperature, gravity or other related physical attributes. In this embodiment, when the LPG is consumed to reach its limit in its gravity of the liquefied petroleum gas (LPG), the signal will then be produced. Besides, the replaceable pressure value which happened from the damage of the pressure vassal can also be detected to give a warning at risk situation. In this embodiment of using the LPG 511, if the sensor installed in the pressure vessel was electronic sensor, there are some risk may happen, such as explosion, by sparkle from the current. However, if this kind of limitation can be approved, this embodiment will not be limited by using only the mechanical sensor, therefore, the electronic sensor can be also applied. When the LPG was consumed at its limit, the mechanical sensor 25 can then produce a detecting result. The detecting result can be converter into an electronic signal to be recorded in the record IC 530 via a converter (not shown in FIG. 6). The electronic signal relates to a residual content volume 536. In this embodiment, the personal digital assistant (PDA) 55 has the function of RFID tag 53, whereas the RFID tag 53 was not only limit existed in the personal digital assistant 55. When the PDA 55 approach to the RFID tag 53, it will then output a radio frequency signal 56, the antenna will then transmit the preset status information 532 and the information of residual content volume 536 to the PDA 55. Therefore, the PDA 55 can determine whether the bottle has expired, needs LPG or to be maintained. Here, the PDA 55 with the RFID tag 53 or other related reading device can be attached to a gas filler (not shown in FIG. 6). When completing the activity of injecting the LPG via the gas filler, the PDA 55 can then record the information of injected LPG volume, the name of examination and other related information, and then transmit this information back to the record IC to update the status information via the antenna for next operation. Moreover, the wireless charging device (not shown in FIG. 6) can be set in the pressure vessel body 51. When the PDA 55 read the RFID tag 53, the electromagnetic wave can be received and then converted to current for storage by the wireless charging device, for providing the power to the radio frequency identification tag, switcher, mechanical sensor or electronic sensor.

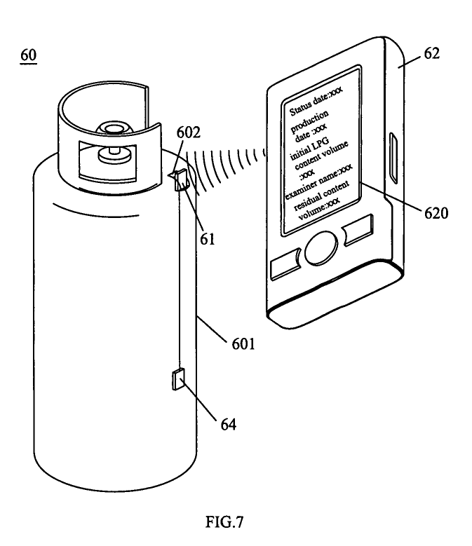

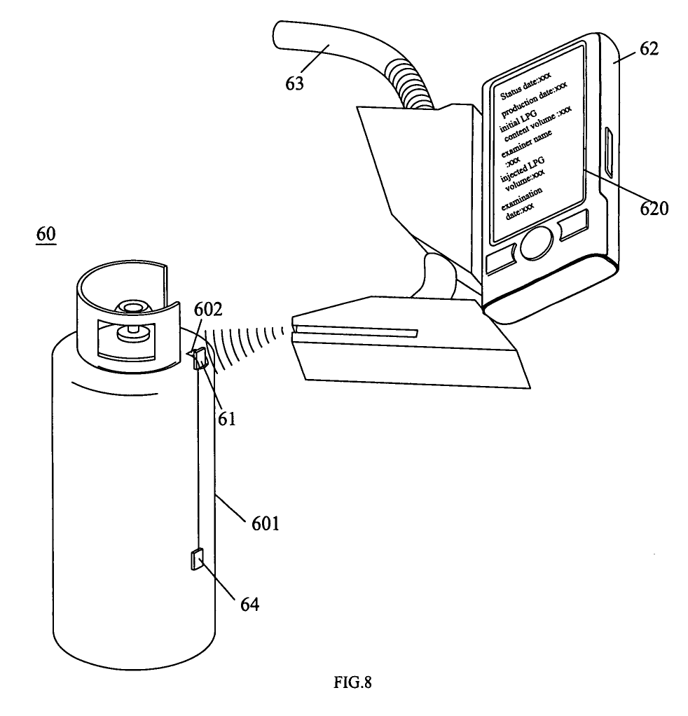

Referring to FIGS. 7 and 8 for a schematic block diagram for a LPG steel bottle apparatus with sensing identification function in accordance with a preferred embodiment of the present invention. The radio frequency identification (RFID) tag 61 is located in the concave container 602 on the surface 601 of the pressure vessel body 60. The personal digital assistant (PDA) 62 with the radio frequency identification tag (RFID) 61 can read the preset statues information, as shown in FIG. 6 comprising the production date, the initial LPG content volume, and the examiner name, and the residual content volume which records in the RFID tag 61 via the mechanical sensor 64 (as shown by dot line) on the surface 601 of the pressure vessel body 60. The display 620 will show the information on its display 620 for operator to verify. Or, as shown in FIG. 8, the PDA 62 can attach to a gas filler 63 for operator to verify when injecting gas to the pressure vessel body 60, and rewrite the information such as the injected LPG volume, the examination date and time in the RFID tag 61 for next validation.

While the invention has been described in terms of specific embodiments of the present invention, it is not limited to such detail since numerous modifications and variations could be made by those skilled in the art without departing from the scope and spirit of the present invention. Therefore, the features and advantages of the present invention will be set forth in the claims.

What is claimed is:

1. A pressure vessel apparatus with sensing identification function comprising:
a pressure vessel body with a concave container located on its surface; and
an identification tag, located in said concave container, comprising a record IC and a communication unit, said record IC for recording a status information of said pressure vessel body;
wherein when said reading device reads said identification tag, and thus provides an identification signal such that said communication unit transmits said status information to said reading device for verification.

2. The pressure vessel apparatus of claim 1, wherein said pressure vessel body is a pressure steel bottle, said pressure steel bottle is a steel bottle which can withstand high pressures.

3. The pressure vessel apparatus of claim 1, wherein said identification tag is glued to said concave container by a viscose.

4. The pressure vessel apparatus of claim 1, wherein said identification tag is a radio frequency identification tag.

5. The pressure vessel apparatus of claim 1, wherein said identification tag is made by material which can withstand high temperature, low temperature, material of sand blasting, water and fire proof, or other material which is capable of resisting environmentally harsh conditions.

6. The pressure vessel apparatus of claim 1, wherein said pressure vessel body is used for containing a content, said content is a liquefied petroleum gas, an oxygen, a nitrogen or other gases.

7. The pressure vessel apparatus of claim 1, wherein said status information comprises a production date, an initial content volume, and an examiner name.

8. The pressure vessel apparatus of claim 1, wherein said communication unit is an antenna.

9. The pressure vessel apparatus of claim 1, wherein reading device is attached to an attachment device, and said attachment device is a gas filler.

10. The pressure vessel apparatus of claim 1, wherein said identification signal is radio frequency identification (RFID) signal.

11. A pressure vessel apparatus with sensing identification function comprising:
a pressure vessel body with a concave container located on the surface of said pressure vessel body; and
a sensing unit, located on the surface of the pressure vessel body, for detecting the status information of a content in said pressure vessel body and generating a detecting result;
an identification tag, located in said concave container, electrically connected to said sensing unit, said identification tag including a record IC and a communication unit; and
a reading device;
wherein said record IC is used for recording a preset status information of said pressure vessel apparatus and said detecting result from said sensing unit, when said reading device reads said identification tag, and thus provides an identification signal such that said communication unit transmits said preset status information and said detecting result to said reading device for verification, and said reading device can update said preset status information and transmit said updated preset status information to said record IC via said communication unit.

12. The pressure vessel apparatus of claim 11, wherein said pressure vessel body is a steel bottle, said pressure steel bottle is a steel bottle which can withstand high pressure.

13. The pressure vessel apparatus of claim 11, wherein said identification tag is glued to said concave container by a viscose.

14. The pressure vessel apparatus of claim 11, wherein said identification tag is a radio frequency identification tag.

15. The pressure vessel apparatus of claim 11, wherein said identification tag is made by material which can withstand high temperature, low temperature, material of sand blasting, water and fire proof, or other material which is capable of resisting environmentally harsh conditions.

16. The pressure vessel apparatus of claim 11, wherein said pressure vessel body is used for containing a content, said content is a liquefied petroleum gas, an oxygen, a nitrogen or other gases.

17. The pressure vessel apparatus of claim 11, wherein said detecting result is a signal with residual content volume.

18. The pressure vessel apparatus of claim 11, wherein said status information comprises a production date, an initial content volume, an examiner name and an expiration date.

19. The pressure vessel apparatus of claim 11, wherein said communication unit is an antenna.

20. The pressure vessel apparatus of claim 11, wherein said sensing unit is a mechanical sensor or an electronic sensor.

21. The pressure vessel apparatus of claim 11, further comprising a power supply unit located in said pressure vessel body, said power supply unit providing the desired power to said sensing unit and said identification tag.

22. The pressure vessel apparatus of claim 21, wherein said power supply unit is a battery or a wireless charging unit, said wireless charging unit is used for receiving an electromagnetic wave which is then converted to current for storage.

23. The pressure vessel apparatus of claim 11, wherein said reading device is attached to an attachment device, said attachment device is a gas filler.

24. The pressure vessel apparatus of claim 11, wherein said identification signal is a radio frequency signal.
